(19) United States
(12) Patent Application Publication
(10) Pub. No.: US 2023/0140584 A1
(43) Pub. Date: May 4, 2023

(54) APPARATUS AND METHODS FOR DETECTING LIGHT-BASED ATTRIBUTES OF ROAD SEGMENTS AND MONITORING THE LIGHT-BASED ATTRIBUTES FOR ADVERSE ROAD CONDITIONS

(71) Applicant: HERE GLOBAL B.V., EINDHOVEN (NL)

(72) Inventors: Leon Stenneth, Chicago, IL (US); Jerome Beaurepaire, Berlin (DE); Jeremy Michael Young, Chicago, IL (US)

(73) Assignee: HERE GLOBAL B.V., EINDHOVEN (NL)

(21) Appl. No.: 17/517,302

(22) Filed: Nov. 2, 2021

(51) Int. Cl. G01C 21/34; G06K 9/46; G06K 9/00; G08G 1/0967; G01C 21/00; G06F 16/29

(52) U.S. Cl. CPC G01C 21/3415; G01C 21/3807; G06F 16/29; G06K 9/00791; G06K 9/4661; G08G 1/0967

(57) ABSTRACT

An apparatus, method and computer program product are provided for providing a map layer of light-based attributes. In one example, the apparatus receives sensor data associated with a road segment and generates a data point for the map layer based on the sensor data. The data point indicates one or more light-based attributes of the road segment. The apparatus stores the data point in a database associated with the map layer. The map layer comprises the data point and one or more other data points that indicate the light-based attributes of one or more other road segments.

### TECHNICAL FIELD

The present disclosure generally relates to the field of mapping light-based attributes of road segments, associated methods and apparatus, and in particular concerns, for example, an apparatus configured to identify attributes of light impacting road segments and monitor the attributes for adverse road conditions.

### BACKGROUND

Light affects a way of which operators maneuver vehicles through a road network. In certain cases, an intensity level of light can increase to a degree that renders unsafe road conditions for vehicles. For example, an intense glare caused by sunlight may impede a driver’s visibility or a sensor’s detectability, or at night-time, light generated from artificial light generating sources (e.g., street lights, building lights, vehicle lights, etc.) can reflect off of precipitation formed on roads and distort shapes of road lane markings, thereby preventing the driver or the vehicle sensor from detecting the road lane markings. Light can also indirectly cause adverse road conditions when light rays reflect off of reflective landmarks and converge to a point. For example, outer surfaces of certain skyscrapers may be formed with light reflecting materials and be concave, thereby reflecting sun rays and causing the light rays to converge to an area. Temperatures within the area can greatly exceed ambient temperatures, thereby causing adverse effects, such as melting or burning physical objects (e.g., a portion of a road segment, vehicles, stationary roadside devices, other buildings, etc.) residing in the area.

The listing or discussion of a prior-published document or any background in this specification should not necessarily be taken as an acknowledgement that the document or background is part of the state of the art or is common general knowledge.

### BRIEF SUMMARY

According to a first aspect, an apparatus comprising at least one processor and at least one non-transitory memory including computer program code instructions is described. The computer program code instructions, when executed, cause the apparatus to receive sensor data associated with a road segment and generate a data point for a map layer associated with the road segment based on the sensor data. The data point indicates one or more natural light-based attributes of the road segment. The computer program code instructions, when executed, further cause the apparatus to store the data point in a database associated with the map layer. The map layer comprises the data point and one or more other data points that indicate the natural light-based attributes of one or more other road segments.

According to a second aspect, a non-transitory computer-readable storage medium having computer program code instructions stored therein is described. The computer program code instructions, when executed by at least one processor, cause the at least one processor to receive location information of a vehicle, identify a target road segment associated with the location information, and determine whether the target road segment is affected by the adverse road condition by using a map layer. The map layer comprises a plurality of data points associated with a plurality of road segments, and each of the plurality of data points indicates light-based attributes of each of the plurality of road segments. The computer program code instructions, when executed by at least one processor, further cause the at least one processor to, responsive to the target road segment being impacted by the adverse road condition: (i) cause a notification to a user device associated with the vehicle; (ii) generate a route to an alternative road segment; or (iii) a combination thereof.

According to a third aspect, a method of providing a map layer is described. The method includes receiving sensor data associated with a road segment and generating a data point for a map layer associated with the road segment based on the sensor data. The data point indicates one or more light-based attributes of the road segment, and the one or more light-based attributes of the road segment indicate the adverse road condition. The method further includes storing the data point in a database associated with the map layer. The map layer comprises the data point and one or more other data points that indicate the one or more light-based attributes of one or more other road segments. The one or more light-based attributes of the one or more other road segments indicates the adverse road condition or one or more other adverse road conditions.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

The steps of any method disclosed herein do not have to be performed in the exact order disclosed, unless explicitly stated or understood by the skilled person.

Corresponding computer programs (which may or may not be recorded on a carrier) for implementing one or more of the methods disclosed herein are also within the present disclosure and encompassed by one or more of the described example embodiments.

The present disclosure includes one or more corresponding aspects, example embodiments or features in isolation or in various combinations whether or not specifically stated (including claimed) in that combination or in isolation. Corresponding means for performing one or more of the discussed functions are also within the present disclosure.

### BRIEF DESCRIPTION OF THE DRAWINGS

The embodiments of the invention are illustrated by way of example, and not by way of limitation, in the figures of the accompanying drawings:

FIG. 1A illustrates a first example image of a daytime environment in which road markings are obscured due to a glare;

FIG. 1B illustrates a second example image of a night-time environment where road markings are obscured due to artificial light rays reflecting off of precipitation formed on the road markings;

FIG. 1C illustrates an example environment in which a reflective building reflects light rays and causes the light rays to converge to a point;

FIG. 2 illustrates a diagram of a system capable of determining light-based attributes of road segments and monitoring the light-based attributes for adverse road conditions;

FIG. 3 illustrates a diagram of the database within the system of FIG. 2;

FIG. 4 illustrates a diagram of the components of the light-based mapping platform within the system of FIG. 2;

FIG. 5 illustrates an example table including light-based attributes for a plurality of road segments at a plurality of time periods;

FIG. 6 illustrates an example visual representation rendered by the presentation module of FIG. 4;

FIG. 7 illustrates a flowchart of a process for generating a data point for a map layer of one or more light-based attributes;

FIG. 8 illustrates a flowchart of a process for notifying a user based on light-based attributes of road segments;

FIG. 9 illustrates a computer system upon which an embodiment may be implemented;

FIG. 10 illustrates a chip set or chip upon which an embodiment may be implemented; and

FIG. 11 illustrates a diagram of exemplary components of a mobile terminal for communications, which is capable of operating in the system of FIG. 2.

### DETAILED DESCRIPTION

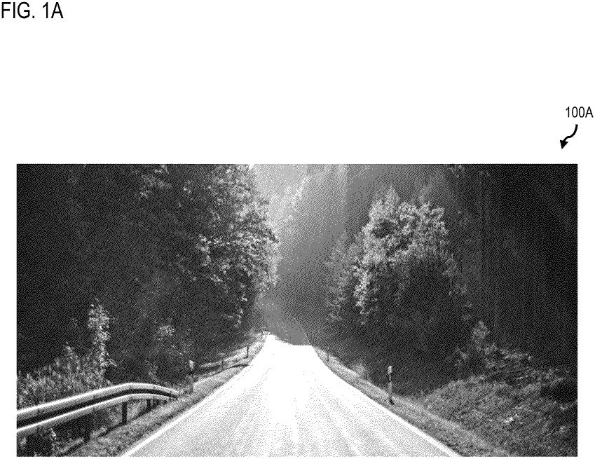

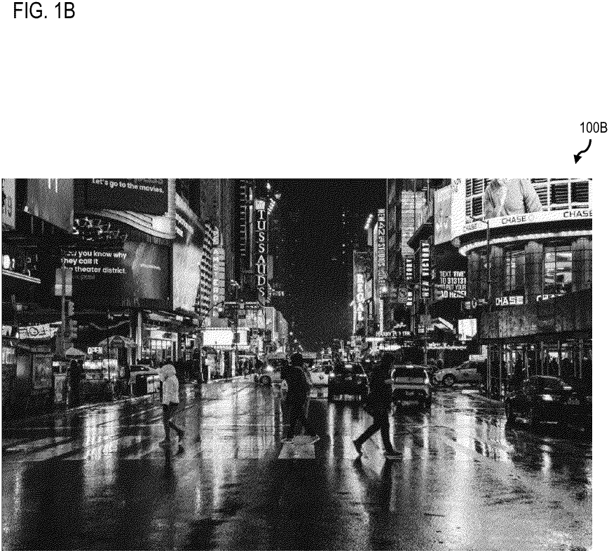

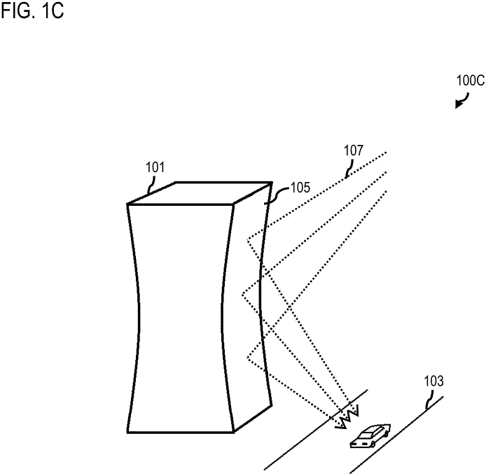

Operators of vehicles rely on light to observe road objects and oncoming road segments; however, excessive amount of light can impede the operator’s visibility, thereby rendering hazard for occupants and pedestrians within a road segment. For example, FIG. 1A includes an example image 100A of a daytime environment in which road markings are obscured due to a glare. In the example image 100A, an intense glare caused by sunlight obscures road markings (i.e., broken white line markings), thereby preventing an operator of the vehicle to observe the road markings. Further, light can also obscure visibility of road objects when semi-transparent or opaque medium exists between a light source and the road objects. For example, FIG. 1B includes an example image 100B of a night-time environment where road markings are obscured due to artificial light rays reflecting off of precipitation formed on the road markings. In the example image 100B, artificial light rays generated from street lights, building lights, vehicle lights, etc. reflect off of precipitation formed on a portion of a road including a crosswalk marking, thereby distorting/disguising the shape and form of the crosswalk. Additionally, indirect lighting can also cause adverse road conditions when light rays reflect off of reflective landmarks and converge to a point. For example, FIG. 1C illustrates an example environment 100C in which a reflective building reflects light rays and causes the light rays to converge to a point. In the illustrate example, a skyscraper 101 is proximate to a road segment 103 and includes a concave outer surface 105 and is formed with light reflecting materials. Light rays 107 from the sun reflect off of the concave outer surface 105 and converge to the road segment 103, thereby increasing temperatures of objects within the road segment 103 and causing adverse effects, such as melting or burning physical objects (e.g., a portion of a road segment, vehicles, stationary roadside devices, other buildings, etc.) residing in the area. There will now be described an apparatus and associated methods that may address these issues.

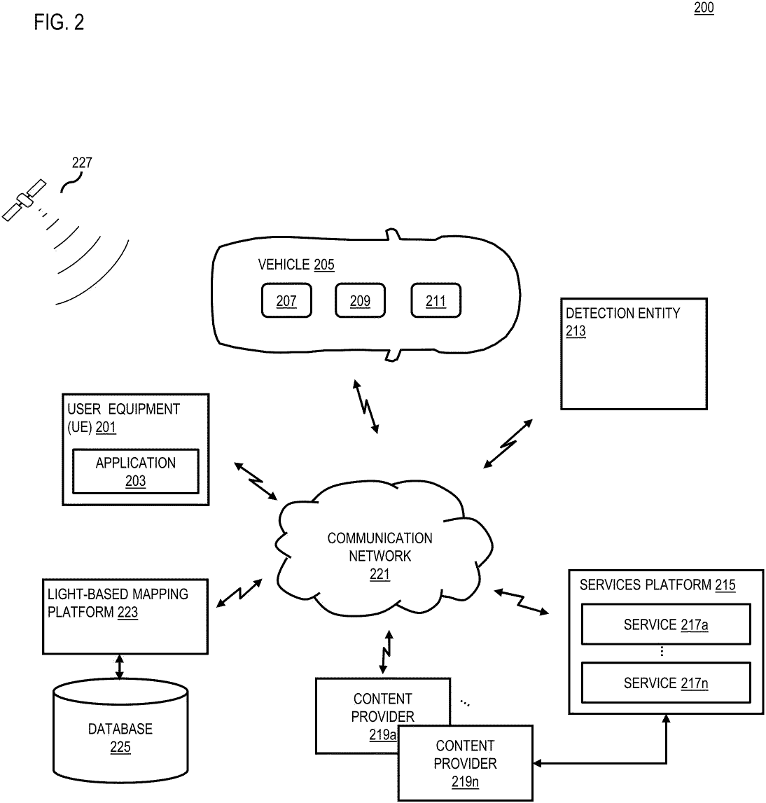

FIG. 2 is a diagram of a system 200 capable of determining light-based attributes of road segments and monitoring the light-based attributes for adverse road conditions, according to one embodiment. A light-based attribute of a road segment may refer to a contrast level of light impacting the road segment, an intensity level of light impacting the road segment, or a temperature level of light impacting the road segment. The system includes a user equipment (UE) 201, a vehicle 205, a detection entity 213, a services platform 215, content providers 219a-219n, a communication network 221, a light-based mapping platform 223, a database 225, and a satellite 227. Additional or a plurality of mentioned components may be provided.

In the illustrated embodiment, the system 200 comprises a user equipment (UE) 201 that may include or be associated with an application 203. In one embodiment, the UE 201 has connectivity to the light-based mapping platform 223 via the communication network 221. The light-based mapping platform 223 performs one or more functions associated with determining light-based attributes of one or more road segments and monitoring the light-based attributes for adverse road conditions. In the illustrated embodiment, the UE 201 may be any type of mobile terminal or fixed terminal such as a mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, devices associated with or integrated with one or more vehicles (including the vehicle 205), or any combination thereof, including the accessories and peripherals of these devices. In one embodiment, the UE 201 can be an in-vehicle navigation system, a personal navigation device (PND), a portable navigation device, a cellular telephone, a mobile phone, a personal digital assistant (PDA), a watch, a camera, a computer, and/or other device that can perform navigation-related functions, such as digital routing and map display. In one embodiment, the UE 201 can be a cellular telephone. A user may use the UE 201 for navigation functions, for example, road link map updates. It should be appreciated that the UE 201 can support any type of interface to the user (such as “wearable” devices, etc.). In one embodiment, the one or more vehicles may have cellular or Wi-Fi connection either through the inbuilt communication equipment or from the UE 201 associated with the vehicles. The application 203 may assist in conveying information regarding at least one attribute associated a road segment via the communication network 221. In one embodiment, the information may indicate one or more light-based attributes associated with the road segment and/or whether an adverse road condition impacts the road segment.

In the illustrated embodiment, the application 203 may be any type of application that is executable by the UE 201, such as a mapping application, a location-based service application, a navigation application, a content provisioning service, a camera/imaging application, a media player application, a social networking application, a calendar application, or any combination thereof. In one embodiment, one of the applications 203 at the UE 201 may act as a client for the light-based mapping platform 223 and perform one or more functions associated with the functions of the light-based mapping platform 223 by interacting with the light-based mapping platform 223 over the communication network 221.

The vehicle 205 may be a standard gasoline powered vehicle, a hybrid vehicle, an electric vehicle, a fuel cell vehicle, and/or any other mobility implement type of vehicle. The vehicle 205 includes parts related to mobility, such as a powertrain with an engine, a transmission, a suspension, a driveshaft, and/or wheels, etc. The vehicle 205 may be a manually controlled vehicle, semi-autonomous vehicle (e.g., some routine motive functions, such as parking, are controlled by the vehicle 205), or an autonomous vehicle (e.g., motive functions are controlled by the vehicle 205 without direct driver input). In this illustrated example, the vehicle 205 includes a plurality of sensors 207, an on-board computing platform 209, and an on-board communication platform 211.

The autonomous level of a vehicle can be a Level 0 autonomous level that corresponds to no automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle. In one embodiment, the UE 201 may be integrated in the vehicle 205, which may include assisted driving vehicles such as autonomous vehicles, highly assisted driving (HAD), and advanced driving assistance systems (ADAS). Any of these assisted driving systems may be incorporated into the UE 201. Alternatively, an assisted driving device may be included in the vehicle 205. The assisted driving device may include memory, a processor, and systems to communicate with the UE 201.

The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) and driving commands or navigation commands.

In one embodiment, the vehicle 205 may be an HAD vehicle or an ADAS vehicle. An HAD vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands.

In the illustrated embodiment, the sensors 207 may include image sensors (e.g., electronic imaging devices of both analog and digital types, which include digital cameras, camera modules, camera phones, thermal imaging devices, radar, sonar, lidar, etc.), a global positioning sensor for gathering location data, a network detection sensor for detecting wireless signals or receivers for different short-range communications (e.g., Bluetooth, Wi-Fi, Li-Fi, near field communication (NFC) etc.), temporal information sensors, an audio recorder for gathering audio data, velocity sensors, light sensors, oriental sensors augmented with height sensor and acceleration sensor, tilt sensors to detect the degree of incline or decline of the vehicle 205 along a path of travel, etc. In a further embodiment, sensors about the perimeter of the vehicle 205 may detect the relative distance of the vehicle 205 from road objects (e.g., road markings), lanes, or roadways, the presence of other vehicles, pedestrians, traffic lights, road objects, road features (e.g., curves) and any other objects, or a combination thereof. In one embodiment, the vehicle 205 may include GPS receivers to obtain geographic coordinates from satellites 227 for determining current location and time associated with the vehicle 205. Further, the location can be determined by a triangulation system such as A-GPS, Cell of Origin, or other location extrapolation technologies. One or more of the sensors 207 may be installed on the exterior surface or external components of the vehicle 205, within the interior cabin of the vehicle 205, between the interior cabin and the exterior surface of the vehicle 205, or a combination thereof.

The on-board computing platform 209 performs one or more functions associated with the vehicle 205. In one embodiment, the on-board computing platform 209 may aggregate sensor data generated by at least one of the sensors 207 and transmit the sensor data via the on-board communications platform 211. The on-board computing platform 209 may receive control signals for performing one or more of the functions from the light-based mapping platform 223, the UE 201, the services platform 215, one or more of the content providers 219a-219n, or a combination thereof via the on-board communication platform 211. The on-board computing platform 209 includes at least one processor or controller and memory (not illustrated). The processor or controller may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, non-volatile solid-state memory, etc.), unalterable memory (e.g., EPROMs), read-only memory, and/or high-capacity storage devices (e.g., hard drives, solid state drives, etc). In some examples, the memory includes multiple kinds of memory, particularly volatile memory and non-volatile memory.

The on-board communications platform 209 includes wired or wireless network interfaces to enable communication with external networks. The on-board communications platform 209 also includes hardware (e.g., processors, memory, storage, antenna, etc.) and software to control the wired or wireless network interfaces. In the illustrated example, the on-board communications platform 209 includes one or more communication controllers (not illustrated) for standards-based networks (e.g., Global System for Mobile Communications (GSM), Universal Mobile Telecommunications System (UMTS), Long Term Evolution (LTE) networks, 5G networks, Code Division Multiple Access (CDMA), WiMAX (IEEE 802.16m); Near Field Communication (NFC); local area wireless network (including IEEE 802.11 a/b/g/n/ac or others), dedicated short range communication (DSRC), and Wireless Gigabit (IEEE 802.11 ad), etc.). In some examples, the on-board communications platform 209 includes a wired or wireless interface (e.g., an auxiliary port, a Universal Serial Bus (USB) port, a Bluetooth® wireless node, etc.) to communicatively couple with the UE 201.

The detection entity 213 may be a vehicle (e.g., similar to the vehicle 205), a drone, a road-side sensor (e.g., a sensor installed within a road pavement), or a device mounted on a stationary object within or proximate to a road segment (e.g., a traffic light post, a sign post, a post, a building, etc.). The detection entity 213 may be equipped with image sensors (e.g., electronic imaging devices of both analog and digital types, which include digital cameras, camera modules, camera phones, thermal imaging devices, radar, sonar, lidar, etc.), light sensors (e.g., photodetectors), and/or temperature sensors. The detection entity 213 may be equipped with additional sensors such as an audio recorder for gathering audio data, velocity sensors, oriental sensors augmented with height sensor and acceleration sensor, tilt sensors, etc. In a further embodiment, sensors about the perimeter of the detection entity 213 may detect the relative distance thereof from road objects (e.g., road markings), lanes, or roadways, the presence of other vehicles, pedestrians, traffic lights, road objects, road features (e.g., curves) and any other objects, or a combination thereof. In one embodiment, the detection entity 213 may include GPS receivers to obtain geographic coordinates from satellites 227 for determining current location and time associated with at which the detection 213 acquires sensor data. The location can be determined by a triangulation system such as A-GPS, Cell of Origin, or other location extrapolation technologies. In one embodiment, if the detection entity 113 is stationary (e.g., a traffic camera) may store contextual information indicating a location at which the detection entity 113 is located, a direction at which a particular sensor (e.g., an image sensor) of the detection entity 113 is facing, or a combination thereof. In one embodiment, the detection entity 213 may be a mobile device (e.g., similar to the UE 201) and may be equipped with image sensors and other sensors (such as an audio recorder, accelerometer, gyroscope, etc.). Such mobile device may be capable of providing images and information indicating a time, location, and orientation at which the images are acquired.

The communication network 221 of system 200 includes one or more networks such as a data network, a wireless network, a telephony network, or any combination thereof. The data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

The service platform 215 may be an original equipment manufacturer (OEM) platform that provides one or more services 217a-217n (collectively referred to as services 217). In one embodiment the one or more service 217 may be sensor data collection services. By way of example, vehicle sensor data provided by the sensors 207 may be transferred to the UE 201, the light-based mapping platform 223, the database 225, or other entities communicatively coupled to the communication network 221 through the service platform 215. The services 217 may also be other third-party services and include mapping services, navigation services, travel planning services, weather-based services, notification services, social networking services, content (e.g., audio, video, images, etc.) provisioning services, application services, storage services, contextual information determination services, location-based services, information-based services, etc. In one embodiment, the services platform 215 uses the output data generated by of the light-based mapping platform 223 to provide services such as navigation, mapping, other location-based services, etc.

In one embodiment, the content providers 219a-219n (collectively referred to as content providers 219) may provide content or data (e.g., including geographic data, parametric representations of mapped features, etc.) to the UE 201, the vehicle 205, services platform 215, the vehicle 205, the database 225, the light-based mapping platform 223, or the combination thereof. The content provided may be any type of content, such as map content, textual content, audio content, video content, image content, etc. In one embodiment, the content providers 219 may provide content that may aid in determining light-based attributes of one or more road segments, monitoring the light-based attributes for adverse road conditions, and/or other related characteristics. In one embodiment, the content providers 219 may also store content associated with the UE 201, the vehicle 205, services platform 215, the vehicle 205, the database 225, the light-based mapping platform 223, or the combination thereof. In another embodiment, the content providers 219 may manage access to a central repository of data, and offer a consistent, standard interface to data, such as a repository of the database 225.

In the illustrated embodiment, the light-based mapping platform 223 may be a platform with multiple interconnected components. The light-based mapping platform 223 may include multiple servers, intelligent networking devices, computing devices, components and corresponding software for determining light-based attributes of one or more road segments and monitoring the light-based attributes for adverse road conditions. It should be appreciated that that the light-based mapping platform 223 may be a separate entity of the system 200, included within the UE 201 (e.g., as part of the applications 103), included within the vehicle 205 (e.g., as part of an application stored in memory of the on-board computing platform 209), included within the services platform 215 (e.g., as part of an application stored in server memory for the services platform 215), or a combination thereof.

The light-based mapping platform 223 may: (1) receive sensor data associated with each of a plurality of road segments; (2) derive light-based attributes associated with each road segment from the sensor data; (3) generate or update a data point for a map layer indicating the light-based attributes for each road segment; (4) if light-based attributes of a road segment satisfy a threshold, identify an adverse road condition; and (5) cause a notification of the adverse road condition or generate a response to the adverse road condition.

The light-based mapping platform 223 receives the sensor data from a plurality of detection entities 213 within a road network. The light-based mapping platform 223 may receive sensor data from two types of detection entities 213: stationary and dynamic detection entities 213. Stationary detection entities 213, such as a road-side sensor or a sensor mounted on another physical object (e.g., a traffic light post, a sign post, a post, a building, etc.), may continuously acquire sensor data for road segments in which the stationary detection entities 213 are disposed. As such, for each of said road segments, the light-based mapping platform 223 may derive light-based attributes from the sensor data over a plurality of periods throughout a day. For example, the light-based mapping platform 223 may acquire a first light contrast level of a road segment, a first light intensity level of the road segment, and a first temperature level of the road segment for a timeslot of 1PM to 2PM and a second light contrast level of the road segment, a second light intensity level of the road segment, and a second temperature level of the road segment for a timeslot of 2PM to 3PM. As for road segments that do not include stationary detection entities 213, the light-based mapping platform 223 may rely on dynamic detection entities 213, such as vehicles, drones, and/or mobile devices. In one embodiment, when a dynamic detection entity 213 acquires sensor data, the dynamic detection entity 213 may provide location and temporal information to indicate a location, orientation, and timing at which the dynamic detection entity 213 has acquired the sensor data. Using the information, the light-based mapping platform 223 derives the light-based attributes from the sensor data for one of the plurality of periods.

It is contemplated that a detection entity 213 may not be within a road segment for one or more of the plurality of periods. As such, the light-based mapping platform 223 may further acquire weather data associated the road segment and the one or more of the plurality of periods. Based on the weather data, the light-based mapping platform 223 may refer to historical data including: (1) past similar weather data associated with the road segment; and (2) light-based attributes associated with the past similar weather data. As such, if the light-based mapping platform 223 fails to record one or more light-based attributes for a given road segment at a given period of a day, the light-based mapping platform 223 may rely on the historical data to identify one or more past light-based attributes of the given road segment. For example, if the light-based mapping platform 223 fails to record a light contrast level of a road segment, a light intensity level of the road segment, and a temperature level of the road segment for a timeslot of 1PM to 2PM on May 8^{th}, the light-based mapping platform 223 acquires weather data associated with the road segment at the time slot of 1AM to 2AM on May 8^{th}. Assuming that the weather data indicate a sunny condition, the light-based mapping platform 223 searches through the historical data to identify a past light contrast level of the road segment, a past light intensity level of the road segment, and a past temperature level of the road segment for a past day that was sunny at the time slot of 1AM to 2AM. If such past levels are found, the light-based mapping platform 223 records the light contrast level, the light intensity level, and the temperature level of the road segment for the timeslot of 1PM to 2PM on May 8^{th} as the past levels.

In one embodiment, in addition to recording light-based attributes for a plurality of road segments and periods within a day, the light-based mapping platform 223 may also acquire information indicating: (1) sun angles with respect to each of the plurality of road segments; (2) location of artificial light sources with respect to each of the plurality of road segments; (3) a timing at which the artificial light sources becomes active; (4) other attributes of the artificial light sources (e.g., a direction at which an artificial light source faces, etc.); or (5) a combination thereof. Such information may be correlated with light-based attributes and used as historical data.

In one embodiment, two or more detection entities 213 may acquire sensor data for a given road segment within a given period. In such embodiment, the light-based mapping platform 223 may aggregate the sensor data and derive an average of the aggregated sensor data. In one embodiment, the light-based mapping platform 223 determines a weighted average of the aggregated sensor data. In such embodiment, the light-based mapping platform 223 may assign a weight to sensor data depending on a type of detection entity 213 that has acquired the sensor data. By way of example, if a vehicle or a sensor installed in a pavement of a road segment has acquired sensor data, the light-based mapping platform 223 may assign a first weight to the sensor data, and if a sensor mounted on another object, such as a traffic/road-side post or a building, has acquired the sensor data, the light-based mapping platform 223 may assign a second weight to the sensor data. In one embodiment, all weights of sensor data may be the same; however, it is contemplated that sensor data acquired from a certain type of detection entities 213 may represent a more accurate measurement of light-based attributes than sensor data acquired from other types of detection entities 213. For example, vehicle sensors and sensors installed in a pavement of a road segment are generally closer to the surface of the road segment in comparison to sensors mounted on traffic/road-side posts or buildings. As such, the light-based mapping platform 223 may set the first weight to be greater than the second weight.

In one embodiment, if the light-based mapping platform 223 receives sensor data from two or more detection entities 213 within a road segment at two or more different locations, the light-based mapping platform 223 may partition the road segment into multiple road segments. While the light-based mapping platform 223 may continue to partition road segments as additional sensor data are acquired at different locations within a road segment, the increased number of road segments inherently requires increased instances in which sensor data are acquired to maintain a map layer that is near real-time. As such, the number of road segments within a given area of a map may be dynamically adjusted. In one embodiment, a number of road segments within a given area of a map may be dependent on an amount of traffic that is within the area of the map. In such embodiment, the light-based mapping platform 223 may increase the number of road segments (and lessen the length of each road segment) in the area if an average amount of traffic within the area increases. Conversely, the light-based mapping platform 223 may decrease the number of road segments (and increase the length of each road segment) in the area if an average amount of traffic within the area decreases.

In one embodiment, as the light-based mapping platform 223 acquires sensor data associated with a road segment and derives light-based attributes from the sensor data, the light-based mapping platform 223 updates a table that aggregates the light-based attributes and other contextual data (e.g., weather data, sun angles, artificial light source attributes, etc.). The table defines, for each road segment: (1) a number of road segments; (2) a parametric offset of said link; (3) a number of time slots within a day; (4) a number of light-based attributes for each of the time slots; and (5) the contextual data. The table may be used to generate datapoints within a may layer of one or more light-based attributes. The datapoints may indicate locations of road segments and the light-based attributes thereof.

In one embodiment, the table may be used to define time points or periods in which: (1) natural light (e.g., sunlight or moonlight) begins to impact a road segment; (2) the natural light stops impacting the road segment; (3) artificial light begins to impact the road segment (e.g., streetlights, building lights, vehicle lights, etc.); (4) the artificial light stops impacting the road segment; or (5) a combination thereof. By way of example, a steady increase in light intensity level and temperature level may indicate that the sun is rising and sunlight is impacting the road segment; whereas a steady decrease of temperature level and a slight decrease of light intensity level may indicate that the sun is setting but artificial light sources proximate to the road segments are being activated.

In one embodiment, as the light-based mapping platform 223 acquires sensor data associated with a road segment and derives light-based attributes from the sensor data, the light-based mapping platform 223 determines whether the light-based attributes of the road segment indicate an adverse road condition. In such embodiment, light-based attributes of a road segment indicating an adverse road condition may resemble a particular set or a combination of thresholds defined by: (1) a contrast level of light impacting the road segment; (2) an intensity level of the light; (3) a temperature level of the light; (4) a sun angle; (5) time of day; (6) a weather condition impacting the road segment; (7) attributes of artificial light sources proximate to the road segment; or (8) a combination thereof. For example, light-based attributes of a road segment satisfying a first set of thresholds may indicate that the road segment is impacted by a glare rendered by sunlight. By way of another example, light-based attributes of a road segment satisfying a second set of thresholds may indicate that road markings and/or other road objects within the road segment is impacted by precipitation and artificial light rays. By way of another example, light-based attributes of a road segment satisfying a third set of thresholds may indicate that attributes of light impacting the road segment is severe enough to damage physical objects within the road segment (e.g., light rays reflecting off reflective buildings and converging to the road segment). In one embodiment, to establish thresholds indicating adverse road conditions, the light-based mapping platform 223 may train a machine learning model by using historical data including past light-based attribute data, contextual data (e.g., weather data, sun angles, artificial light source attributes, etc.), and ground truth data indicating true states of road conditions. The ground truth data may indicate a recorded event of an adverse road condition (e.g., a vehicle camera fails to identify a road object due to a glare), and the light-based attribute data and the contextual data corresponding to the recorded event may be used as the thresholds.

If the light-based attributes of a road segment satisfy the first set, the second set, or the third set of thresholds, the light-based mapping platform 223 may: (1) a notification indicating an adverse condition corresponding to each set of thresholds that is satisfied; (2) generate a route based on the road segment (e.g., generate a route that avoids the road segment); (3) cause vehicles that are traversing or will be traversing the road segment to switch from a first set of sensors to a second set of sensors (e.g., changing from lidar to high-definition cameras); (4) cause autonomous or semi-autonomous vehicles that are traversing or will be traversing the road segment to switch a way of which the vehicles are being maneuvered (e.g., switching from autonomous mode to manual mode); (5) update the table to include an indication of the adverse road condition (e.g., a flag); or (6) a combination thereof. In one embodiment, if the light-based mapping platform 223 determines that a vehicle will be traversing such road segment, the light-based mapping platform 223 may allow the vehicle to traverse the road segment if the vehicle is following a leading vehicle that has predetermined attributes and will also be traversing the road segment. By way of example, such predetermined attributes may indicate that the leading vehicle has physical characteristics that may assist in mitigating the adverse road condition for the following vehicle (e.g., rear dimensions of the leading vehicle large enough to mitigate a glare from sunlight). In one embodiment, if the light-based mapping platform 223 determines that a vehicle will be traversing a road segment that satisfies the first and/or the third set of thresholds, the light-based mapping platform 223 may cause one or more drones to be deployed to the road segment to mitigate the adverse road condition. By way of example, if the road segment is impacted with a glare from sunlight, the one or more drones may be instructed to block the glare for the vehicle, or if the road segment is impacted with an intense ray of light, the one or more drones may be instructed to block the ray of light for the vehicle and/or provide a heat resisting solution (e.g., water) to the vehicle.

In one embodiment, if the light-based attributes of a road segment satisfy the first set, the second set, or the third set of thresholds, the light-based mapping platform 223 may generate an indication (e.g., a flag) that the road segment requires an investigation for identifying a cause of the adverse road condition occurring within the road segment. In such embodiment, sensor data, such as image data, acquired in the road segment may be investigated via a machine learning model or human analysis to render the cause of the adverse road condition. Once the cause of the adverse road condition is identified, the cause may be associated with the light-based attributes, the time slot in which the first set, the second set or the third set of thresholds was satisfied, other contextual data and stored as historical data. As such, as the light-based mapping platform 223 acquires sensor data indicating similar light-based attributes indicating existence of an adverse road condition, the light-based mapping platform 223 may use the historical data to render the cause of the adverse road condition. By way of example, if light-based attributes of a road segment satisfy the third set of thresholds (i.e., attributes of light impacting the road segment is severe enough to damage physical objects within the road segment) at a time slot, the light-based mapping platform 223 may acquire image data including images captured at the road segment (e.g., images captured via the vehicle 205, the detection entity 213, a drone or a field personnel deployed by an establishment, etc.) and within the time slot. In such example, the image may be analysed, and the cause of the adverse road condition may be identified. The analysis may indicate that a reflective skyscraper proximate to the road segment causes sun light to converge to the road segment, thereby rendering the road segment. As such, the light-based mapping platform 223 may store such analysis as historical data, and if the light-based mapping platform 223 subsequently acquires similar light-based attributes for a different road segment indicating existence of the adverse road condition, the light-based mapping platform 223 may use the historical data to identify whether a building similar to the reflective skyscraper is proximate to the different road segment and is causing the adverse road condition. Since the light-based mapping platform 223 is capable of identifying a cause of an adverse road condition within a road segment, such information may be used to strategically design and/or construct objects (e.g., road objects, buildings) within or proximate to the road segment to mitigate potential occurrence of the adverse road condition in the road segment or other similar road segments.

In the illustrated embodiment, the database 225 stores information on road links (e.g., road length, road breadth, slope information, curvature information, etc.) and probe data for one or more road links (e.g., traffic density information). In one embodiment, the database 225 may include any multiple types of information that can provide means for aiding in determining light-based attributes of one or more road segments and monitoring the light-based attributes for adverse road conditions. It should be appreciated that the information stored in the database 225 may be acquired from any of the elements within the system 100, other vehicles, sensors, database, or a combination thereof.

In one embodiment, the UE 201, the vehicle 205, the detection entity 213, the service platform 215, the content providers 219, the light-based mapping platform 223 communicate with each other and other components of the communication network 221 using well known, new or still developing protocols. In this context, a protocol includes a set of rules defining how the network nodes within the communication network 221 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

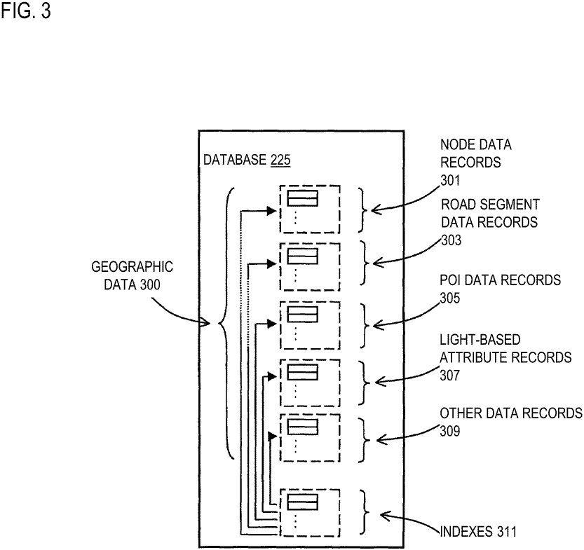

FIG. 3 is a diagram of a database 225 (e.g., a map database), according to one embodiment. In one embodiment, the database 225 includes geographic data 300 used for (or configured to be compiled to be used for) mapping and/or navigation-related services. In one embodiment, the following terminology applies to the representation of geographic features in the database 225.
a. “Node” - A point that terminates a link.
b. “road/line segment” - A straight line connecting two points.
c. “Link” (or “edge”) - A contiguous, non-branching string of one or more road segments terminating in a node at each end.

In one embodiment, the database 225 follows certain conventions. For example, links do not cross themselves and do not cross each other except at a node. Also, there are no duplicated shape points, nodes, or links. Two links that connect each other have a common node.

As shown, the database 225 includes node data records 301, road segment or link data records 303, point of interest (POI) data records 305, light-based attribute records 307, other records 309, and indexes 311, for example. More, fewer or different data records can be provided. In one embodiment, additional data records (not shown) can include cartographic (“carto”) data records, routing data, and maneuver data. In one embodiment, the indexes 311 may improve the speed of data retrieval operations in the database 225. In one embodiment, the indexes 311 may be used to quickly locate data without having to search every row in the database 225 every time it is accessed.

In exemplary embodiments, the road segment data records 303 are links or segments representing roads, streets, or paths, as can be used in the calculated route or recorded route information for determination of one or more personalized routes. The node data records 301 are end points (such as intersections) corresponding to the respective links or segments of the road segment data records 303. The road link data records 303 and the node data records 301 represent a road network, such as used by vehicles, cars, and/or other entities. Alternatively, the database 225 can contain path segment and node data records or other data that represent pedestrian paths or areas in addition to or instead of the vehicle road record data, for example.

Links, segments, and nodes can be associated with attributes, such as geographic coordinates, street names, address ranges, speed limits, turn restrictions at intersections, presence of a construction work site, and other navigation related attributes, as well as POIs, such as gasoline stations, hotels, restaurants, museums, stadiums, offices, automobile dealerships, auto repair shops, buildings, stores, parks, etc. The database 225 can include data about the POIs and their respective locations in the POI data records 305. The data about the POIs may include attribute data associated with the POIs. The attribute data may indicate a type of POI, a shape of POI, a dimension(s) of POI, a number of stories included in each of the POIs, whether one or more outer surfaces of the POI is formed with light-reflecting materials, one or more artificial light sources associated with the POIs (e.g., building lights), a position/orientation of the one or more artificial light sources, timing at which the one or more artificial light sources are activated, attribute associated with the one or more artificial light sources (e.g., color, intensity, etc.), etc. The database 225 can also include data about places, such as cities, towns, or other communities, and other geographic features, such as bodies of water, mountain ranges, etc. Such place or feature data can be part of the POI data records 305 or can be associated with POIs or POI data records 305 (such as a data point used for displaying or representing a position of a city).

The Light-based attribute records 307 include a table that aggregates light-based attributes and other contextual data (e.g., weather data, sun angles, artificial light source attributes, etc.) associated with each road segment of a plurality of road segments stored in the road segment data records 303. The table includes, for each road segment: (1) a number of road segments; (2) a parametric offset of said link; (3) a number of time slots within a day; (4) a number of light-based attributes for each of the time slots; and (5) the contextual data. The table may also include indicators (e.g., a flag) representing whether light-based attributes of a given road segment at a given time slot indicate existence of an adverse road condition. The table may further indicate a type of adverse road condition that the light-based attributes satisfy (i.e., the first, second, and third thresholds). The table may further indicate a cause for an adverse road condition within a given road segment at a given time slot. The table may further include an indicator (e.g., a flag) representing whether a road segment that has satisfied a set of thresholds has been investigated. The light-based attribute records 307 may further include a map layer of one or more light-based attributes that is derived from the table. The map layer may include near real-time datapoints indicating locations of road segments, the light-based attributes thereof, and one or more road segments impacted by an adverse road condition.

Other records 309 may include data associated one or more artificial light sources that are not associated with POIs (e.g., streetlights). Such data may include attribute data indicating a position/orientation of the one or more artificial light sources, timing at which the one or more artificial light sources are activated, attribute associated with the one or more artificial light sources (e.g., color, intensity, etc.), dimensions, orientation, type, classification, etc.

In one embodiment, the database 225 can be maintained by one or more of the content providers 219 in association with a map developer. The map developer can collect geographic data to generate and enhance the database 225. There can be different ways used by the map developer to collect data. These ways can include obtaining data from other sources, such as municipalities or respective geographic authorities. In addition, the map developer can employ field personnel to travel by vehicle along roads throughout the geographic region to observe road signs and/or record information about them, for example. Also, remote sensing, such as aerial or satellite photography, can be used.

The database 225 can be a master database stored in a format that facilitates updating, maintenance, and development. For example, the master database or data in the master database can be in an Oracle spatial format or other spatial format (e.g., accommodating different map layers), such as for development or production purposes. The Oracle spatial format or development/production database can be compiled into a delivery format, such as a geographic data files (GDF) format. The data in the production and/or delivery formats can be compiled or further compiled to form database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by the vehicle 205, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received database in a delivery format to produce one or more compiled navigation databases.

The processes described herein for providing a map layer of one or more light-based attributes and monitoring the light-based attributes for adverse road conditions may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

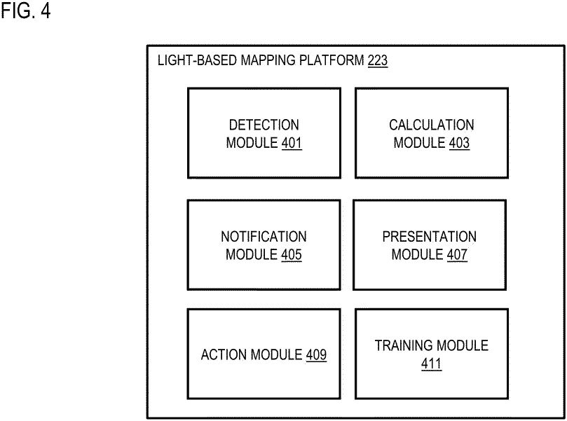

FIG. 4 is a diagram of the components of the light-based mapping platform 223, according to one embodiment. By way of example, the light-based mapping platform 223 includes one or more components for providing a map layer of one or more light-based attributes and monitoring the light-based attributes for adverse road conditions. It is contemplated that the functions of these components may be combined in one or more components or performed by other components of equivalent functionality. In this embodiment, the light-based mapping platform 223 includes a detection module 401, a calculation module 403, a notification module 405, a presentation module 407, a control or action module 409 and a training module 411.

The detection module 401 may acquire data for determining light-based attributes of road segments. Specifically, the detection module 401 may acquire sensor data from a plurality of detection entities 213 within a road network. Sensor data may be provided with: (1) location information indicating a location in which a detection entity 213 has acquired the sensor data; (2) temporal information indicating a timing at which a detection entity 213 has acquired the sensor data; and (3) attribute data indicating a type of detection entity 213 (e.g., whether the detection entity 213 is static or dynamic, whether the detection entity 213 is installed in a pavement or on a post or a building, etc.). The detection module 401 may also acquire, for each road segment within a road network, contextual information such as: (1) weather data associated with said road segment; (2) a sun angle associated with said road segment at a given time slot within a day; (3) attribute data associated with one or more POIs that is within a predetermined distance from said road segment (e.g., a location of a POI, a type of POI, dimension of location of artificial light sources with respect to each of the plurality of road segments; (4) a timing at which the artificial light sources becomes active; (4) other attributes of the artificial light sources (e.g., a direction at which an artificial light source faces, etc.); or (5) a combination thereof. The detection module 401 may acquire such information from services one or more detection entities 213, services platform 215, content provider 219, the database 225, or a combination thereof.

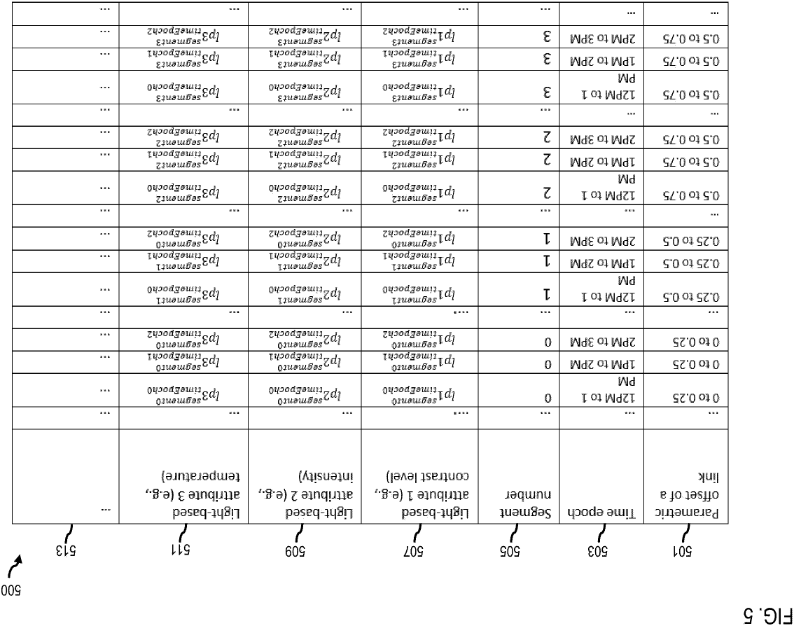

As the detection module 401 acquires sensor data associated with a road segment, the calculation module 403 derives light-based attributes from the sensor data and updates a table that aggregates the light-based attributes and other contextual data (e.g., weather data, sun angles, artificial light source attributes, etc.). For example, FIG. 5 illustrates an example table 500 including light-based attributes for a plurality of road segments at a plurality of time periods. In the illustrated example, the table 500 includes a plurality of columns 501, 503, 505, 507, 509, 511, and 513 defining a parametric offset of a link, time epoch, segment number, a first light-based attribute, a second light light-based attribute, a third light light-based attribute, and other data associated with each road segment, respectively. The parametric offset defines a length of a specific road segment of a road link, and the time epoch defines a specific period within a day. The first light light-based attribute may be a contrast level of light impacting a road segment at a period, the second light light-based attribute may be an intensity level of the light impacting the road segment at the period, and the third light-based attribute may be a temperature level of the light impacting the road segment at the period. Other data may indicate: (1) weather data indicating a weather condition impacting the road segment at the period; (2) an angle of the sun impacting the road segment at the period; (3) attributes of artificial light sources within or proximate to the road segment (e.g., locations of the artificial light sources, angles at which the artificial light sources project light, timings at which the artificial light sources are activated, etc.); (4) existence of an adverse road condition; (5) a type of adverse road condition; (6) information associated with the cause of the adverse road condition; or (7) a combination thereof. The table may be used to generate datapoints within a map layer of one or more light-based attributes. The datapoints may indicate locations of road segments and the light-based attributes thereof. In one embodiment, the table may be used to define time points or periods in which: (1) natural light (e.g., sunlight or moonlight) begins to impact a road segment; (2) the natural light stops impacting the road segment; (3) artificial light begins to impact the road segment (e.g., streetlights, building lights, vehicle lights, etc.); (4) the artificial light stops impacting the road segment; or (5) a combination thereof.

In one embodiment, each of the light-based attributes may represent an average value of a plurality of sensor data acquire over a period. For example, in view of FIG. 5, a contrast level for road segment “0” during a period of 12PM to 1PM may be an average of a plurality of contrast levels derived from all sensor data acquired at the road segment “0” during the period of 12PM to 1PM. In one embodiment, each of the light-based attributes may represent a weighted average value of a plurality of sensor data acquired over a period. In such embodiment, the calculation module 403 may assign a weight to sensor data depending on a type of detection entity 213 that has acquired the sensor data. By way of example, if a vehicle or a sensor installed in a pavement of a road segment has acquired sensor data, the calculation module 403 may assign a first weight to the sensor data, and if a sensor mounted on another object, such as a traffic/road-side post or a building, has acquired the sensor data, the calculation module 403 may assign a second weight to the sensor data. In one embodiment, all weights of sensor data may be the same; however, it is contemplated that sensor data acquired from a certain type of detection entities 213 may represent a more accurate measurement of light-based attributes than sensor data acquired from other types of detection entities 213. For example, vehicle sensors and sensors installed in a pavement of a road segment are generally closer to the surface of the road segment in comparison to sensors mounted on traffic/road-side posts or buildings. As such, the calculation module 403 may set the first weight to be greater than the second weight.

In one embodiment, if the calculation module 403 receives sensor data from two or more detection entities 213 within a road segment at two or more different locations, the calculation module 403 may partition the road segment into multiple road segments. For example, referring to back FIG. 5, the calculation module 403 may partition segment number “0” into two road segments, where the parametric offsets of the two road segments are 0 to 0.125 and 0.125 to 0.25, respectively. While the calculation module 403 may continue to partition road segments as additional sensor data are acquired at different locations within a road segment, the increased number of road segments inherently requires increased instances in which sensor data are acquired to maintain a map layer that is near real-time. As such, the number of road segments within a given area of a map may be dynamically adjusted. In one embodiment, a number of road segments within a given area of a map may be dependent on an amount of traffic that is within the area of the map. In such embodiment, the calculation module 403 may increase the number of road segments (and lessen the length of each road segment) in the area if an average amount of traffic within the area increases. Conversely, the calculation module 403 may decrease the number of road segments (and increase the length of each road segment) in the area if an average amount of traffic within the area decreases.

In one embodiment, the detection module 401 may fail to acquire one or more light-based attributes for a given road segment at a given period of a day (e.g., a detection entity 213 is not within the road segment at the period). In such embodiment, the calculation module 403 relies on historical data (e.g., the table 500) to identify one or more past light-based attributes of the given road segment that corresponds to the given period and the weather condition of the given road segment and period. For example, referring back to FIG. 5, if the detection module 401 fails to acquire the first to third light-based attributes associated with road segment “0” at a period of 3PM to 4PM, the calculation module 403 may search for past light-based attributes of the road segment “0” at the period of 3PM to 4PM from one or more past days. The search for the past light-based attributes may be further narrowed based on a type of weather condition impacting the road segment “0” at the period of 3PM to 4PM. Once the calculation module 403 identifies past light-based attributes, the calculation module 403 may define the light-based attributes of the road segment “0” at the period of 3PM to 4PM as the past light-based attributes.

In one embodiment, the calculation module 403 may identify a road segment as being impacted by an adverse road condition if light-based attributes of the road segment satisfy a particular set or a combination of thresholds. Such set of thresholds may be defined by: (1) a contrast level of light impacting the road segment; (2) an intensity level of the light; (3) a temperature level of the light; (4) a sun angle; (5) time of day; (6) a weather condition impacting the road segment; (7) attributes of artificial light sources proximate to the road segment; or (8) a combination thereof. In one embodiment, the calculation module 403 may define: (1) light-based attributes of a road segment satisfying a first set of thresholds as indicating that the road segment is impacted by a glare rendered by sunlight; (2) light-based attributes of a road segment satisfying a second set of thresholds as indicating that road markings and/or other road objects within the road segment is impacted by precipitation and artificial light rays; and (3) light-based attributes of a road segment satisfying a third set of thresholds as indicating that attributes of light impacting the road segment is severe enough to damage physical objects within the road segment (e.g., light rays reflecting off reflective buildings and converging to the road segment). In one embodiment, to establish thresholds indicating adverse road conditions, the calculation module 403 may train a machine learning model by using historical data including past light-based attribute data, contextual data (e.g., weather data, sun angles, artificial light source attributes, etc.), and ground truth data indicating true states of road conditions. The ground truth data may indicate a recorded event of an adverse road condition (e.g., a vehicle camera fails to identify a road object due to a glare), and the light-based attribute data and the contextual data corresponding to the recorded event may be used as the thresholds.

In one embodiment, if the light-based attributes of a road segment satisfy the first set, the second set, or the third set of thresholds, the calculation module 403 may generate an indication (e.g., a flag) that the road segment requires an investigation for identifying a cause of the adverse road condition occurring within the road segment. In such embodiment, sensor data, such as image data, acquired in the road segment may be investigated via a machine learning model or human analysis to render the cause of the adverse road condition. Once the cause of the adverse road condition is identified, the cause may be associated with the light-based attributes, the time slot in which the first set, the second set or the third set of thresholds was satisfied, other contextual data and stored as historical data. As such, as the calculation module 403 subsequently acquires sensor data indicating similar light-based attributes indicating existence of an adverse road condition, the calculation module 403 may use the historical data to render the cause of the adverse road condition. By way of example, if light-based attributes of a road segment satisfy the third set of thresholds (i.e., attributes of light impacting the road segment is severe enough to damage physical objects within the road segment) at a time slot, the calculation module 403 may acquire image data including images captured at the road segment (e.g., images captured via the vehicle 205, the detection entity 213, a drone or a field personnel deployed by an establishment, etc.) and within the time slot. In such example, the image may be analyzed, and the cause of the adverse road condition may be identified. The analysis may indicate that a reflective skyscraper proximate to the road segment causes sun light to converge to the road segment, thereby rendering the adverse road condition. As such, the calculation module 403 may store such analysis as historical data, and if the calculation module 403 subsequently acquires similar light-based attributes for a different road segment indicating existence of the adverse road condition, the calculation module 403 may use the historical data to identify whether a building similar to the reflective skyscraper is proximate to the different road segment and is causing the adverse road condition. Since the calculation module 403 is capable of identifying a cause of an adverse road condition within a road segment, such information may be used to strategically design and/or construct objects (e.g., road objects, buildings) within or proximate to the road segment to mitigate potential occurrence of the adverse road condition in the road segment or other similar road segments.

The notification module 405 may cause a notification to the UE 201 on: (1) any of the information recorded in a table that associated light-based attributes to road segments (e.g., the table 500 of FIG. 5); (2) a route generated in view of a road segment impacted by an adverse road condition; (3) message indicating that a response will be or is being issued to remedy the adverse road condition (e.g., a fleet of drones is being deployed to block sunlight); or (4) a combination thereof. The notification may include sound notification, display notification, vibration, or a combination thereof. In one embodiment, the notification module 305 may provide the notification to a local municipality/establishment.

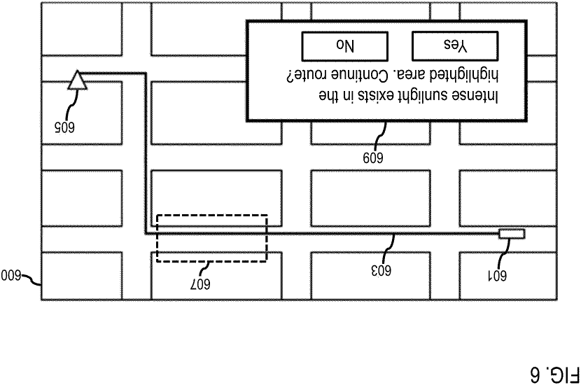

The presentation module 407 obtains a set of information, data, and/or calculated results from other modules, and continues with providing a presentation of a visual representation to the UE 101. The visual representation may indicate any of the information presented by the notification module 405. For example, FIG. 6 illustrates an example visual representation 600 rendered by the presentation module 407. In the illustrated embodiment, the example visual representation 600 is a map including a representation of a vehicle 601, a route 603, a destination 605, a highlighted portion 607, and a message 609. In the illustrate embodiment, the highlighted portion 607 is impacted by an adverse road condition caused by an intense sunlight. As such, the presentation module 407 has generated the message 609 stating “INTENSE SUNLIGHT EXISTS IN THE HIGHLIGHTED AREA. CONTINUE ROUTE?” and including a “YES” and “NO” prompt. In one embodiment, the visual representation may be presented as a combination of map layers including a map layer including one or more light-based attributes and other map layers indicating other information such road link, segment, node information, POI information, a type of weather affecting one or more areas, etc.

The action module 409 generates commands based on analysis executed by the calculation module 403. By way of example, if the calculation module 403 determines that a road segment includes an adverse road condition, the action module 409 may: (1) cause vehicles that are traversing or will be traversing the road segment to switch from a first set of sensors to a second set of sensors (e.g., changing from lidar to high-definition cameras); (2) cause autonomous or semi-autonomous vehicles that are traversing or will be traversing the road segment to switch a way of which the vehicles are being maneuvered (e.g., switch from autonomous mode to manual mode); (3) cause one or more drones to be deployed to the road segment to mitigate the adverse road condition (e.g., if the road segment is impacted with a glare from sunlight, the one or more drones may be instructed to block the glare for the vehicle, or if the road segment is impacted with an intense ray of light, the one or more drones may be instructed to block the ray of light for the vehicle and/or provide a heat resisting solution to the vehicle); or (4) a combination thereof.

The training module 411 may embody machine learning models for: (1) establishing thresholds of light-based attributes that indicate adverse road conditions; (2) identifying a cause of an adverse road condition; or (3) a combination thereof. Such machine learning models may be trained by using historical data including past light-based attribute data, contextual data (e.g., weather data, sun angles, artificial light source attributes, etc.), and ground truth data indicating true states of road conditions. The ground truth data may indicate a recorded event of an adverse road condition (e.g., a vehicle camera fails to identify a road object due to a glare), and the light-based attribute data and the contextual data corresponding to the recorded event may be used as the thresholds and/or the causes of adverse road conditions. In one embodiment, the machine learning models may be random forest, logistic, decision trees, neural networks, or a combination thereof.

The above presented modules and components of the light-based mapping platform 223 can be implemented in hardware, firmware, software, or a combination thereof. Though depicted as a separate entity in FIG. 4, it is contemplated that the light-based mapping platform 223 may be implemented for direct operation by the UE 201, the vehicle 205, the services platform 215, one or more of the content providers 219, or a combination thereof. As such, the light-based mapping platform 223 may generate direct signal inputs by way of the operating system of the UE 201, the vehicle 205, the services platform 215, the one or more of the content providers 219, of the combination thereof for interacting with the applications 203. The various executions presented herein contemplate any and all arrangements and models.

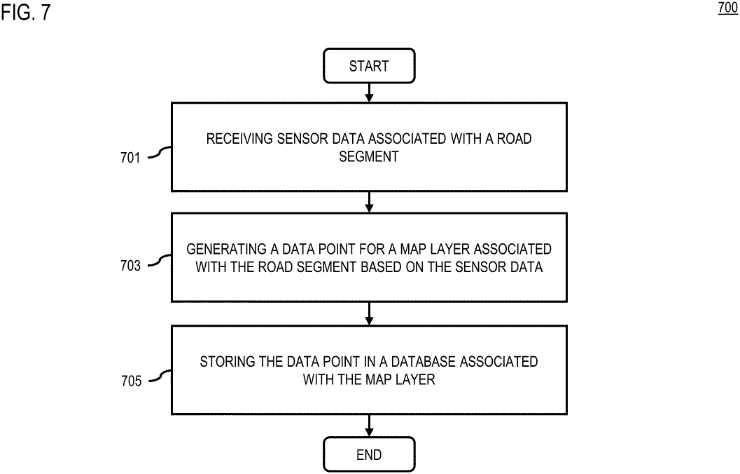

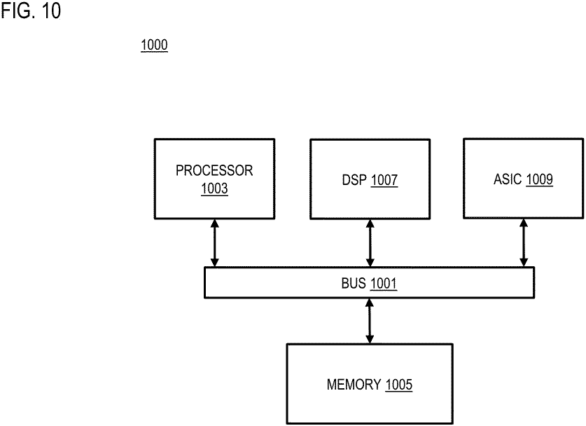

FIG. 7 is a flowchart of a process 700 for generating a data point for a map layer of one or more light-based attributes, according to one embodiment. In one embodiment, the light-based mapping platform 223 performs the process 700 and is implemented in, for instance, a chip set including a processor and a memory as shown in FIG. 10.

In step 701, the light-based mapping platform 223 receives sensor data associated with a road segment. The sensor data may be acquired by one or more detection entities 213 that is installed within the road segment or traverses the road segment. The sensor data may be associated with one of a plurality of periods of a day. The sensor data may be an average of all the sensor data acquired within a road segment over a period. In one embodiment, one or more of the sensor data may be weighted differently (e.g., depending on a type of sensor that has acquired each sensor data, and all the sensor data acquired within a road segment over a period may be defined as a weighted average.

In step 703, the light-based mapping platform 223 generates a data point for a map layer associated with the road segment based on the sensor data. The data point indicates one or more light-based attributes of a road segment. The light-based attributes may be contrast levels of light impacting the road segment, intensity levels of light impacting the road segment, temperature levels of light impacting the road segment, or a combination thereof. In one embodiment, light-based attributes may be classified as natural light-based attributes and/or artificial light-based attributes. Such classification may be based on: (1) a time of day at which sensor data is acquired; (2) a sun angle with respect to a road segment; (3) weather condition associated with the road segment; (4) attributes of one or more artificial light generating sources within or proximate to the road segment; or (5) a combination thereof.

In step 705, the light-based mapping platform 223 stores the data point in a database associated with the map layer. The map layer includes the data point and one or more other data points that indicate the light-based attributes of one or more other road segments. In one embodiment, the light-based mapping platform 223 may store additional data points associated with the road segment. For example, such data points may indicate: (1) whether the one or more light-based attributes indicate an adverse road condition; (2) weather data associated with the road segment; (3) a sun angle; (4) time of day; (5) attributes of artificial light sources proximate to the road segment; (6) a cause of the adverse road condition; or (7) a combination thereof.

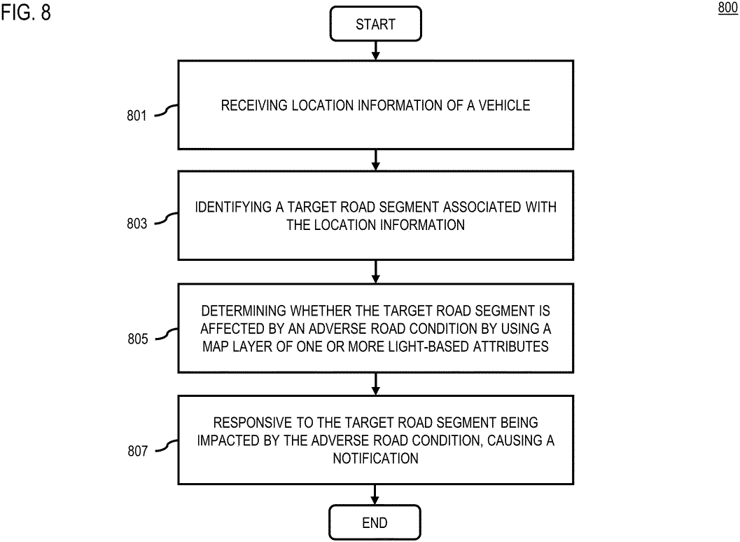

FIG. 8 is a flowchart of a process 500 for notifying a user based on light-based attributes of road segments, according to one embodiment. In one embodiment, the light-based mapping platform 223 performs the process 800 and is implemented in, for instance, a chip set including a processor and a memory as shown in FIG. 10.

In step 801, the light-based mapping platform 223 receives location information associated with a vehicle. The location information may indicate GPS coordinates of the vehicle. In one embodiment, the light-based mapping platform 223 may receive route information associated with the vehicle.

In step 803, the light-based mapping platform 223 identifies a target road segment associated with the location information. The target road segment may be a current road segment in which the vehicle is positioned. Alternatively, the target road segment may be an untraversed road segment within a route of the vehicle.

In step 805, the light-based mapping platform 223 determines whether the target road segment is affected by an adverse road condition by using a map layer of one or more light-based attributes. Specifically, the light-based mapping platform 223: (1) identifies the light-based attributes of the target road segment by identifying the corresponding road segment from the map layer; and (2) determines whether light-based attributes of the target road segment indicate an existence of an adverse road condition. The light-based mapping platform 223 may determine that the light-based attributes indicate the existence of the adverse road condition if the light-based attributes satisfy a set of thresholds. For example: (1) light-based attributes of a road segment satisfying a first set of thresholds may indicate that the road segment is impacted by a glare rendered by sun; (2) light-based attributes of a road segment satisfying a second set of thresholds may indicate that road markings and/or other road objects within the road segment is impacted by precipitation and artificial light rays; and (3) light-based attributes of a road segment satisfying a third set of thresholds may indicate that attributes of light impacting the road segment is severe enough to damage physical objects within the road segment (e.g., light rays reflecting off of reflective buildings and converging to the road segment).

In step 807, if the light-based mapping platform 223 determines that the target road segment is being impacted by the adverse road condition, the light-based mapping platform 223 may cause a notification to a user device associated with the vehicle, the vehicle, or a combination thereof. The notification may indicate: (1) that the target road segment is being impacted by the adverse road condition; (2) a type of adverse road condition; (3) a route generated based on the location of the target road segment (e.g., a route that avoids the target road segment); (4) a cause of the adverse road segment; (5) weather condition associated with the target road segment; (6) sun angle of sunlight impacting the target road segment; (7) light-based attributes of the target road segment; (8) a combination thereof.

The system, apparatus, and methods described herein enable a map-based server/platform to provide a map layer of light-based attributes, determine adverse road conditions based on light-based attributes, and informing vehicle operators. Further, since the operators are informed regarding the adverse road conditions prior to encountering road segments impacted by said conditions, overall safety within a road network is improved.

The processes described herein may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

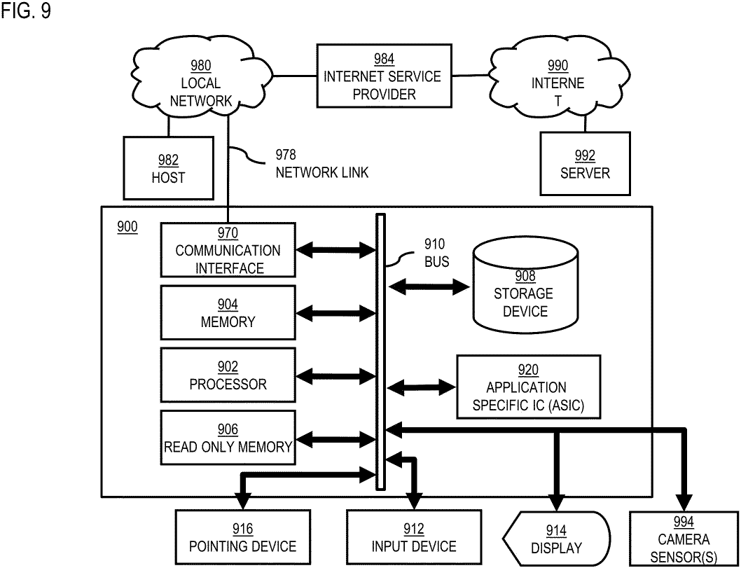

FIG. 9 illustrates a computer system 900 upon which an embodiment may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to determine light-based attributes of one or more road links and monitor the light-based attributes for adverse road conditions, as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for determining light-based attributes of one or more road links and monitoring the light-based attributes for adverse road conditions.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to determining light-based attributes of one or more road links and monitoring the light-based attributes for adverse road conditions. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 900 also includes a memory 904 coupled to bus 910. The memory 904, such as a random access memory (RAM) or any other dynamic storage device, stores information including processor instructions for determining light-based attributes of one or more road links and monitoring the light-based attributes for adverse road conditions. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for determining light-based attributes of one or more road links and monitoring the light-based attributes for adverse road conditions, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914, and one or more camera sensors 9104 for capturing, recording and causing to store one or more still and/or moving images (e.g., videos, movies, etc.) which also may comprise audio recordings. In some embodiments, for example, in embodiments in which the computer system 900 performs all functions automatically without human input, one or more of external input device 912, display device 914 and pointing device 916 may be omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general, the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 221 for determining light-based attributes of one or more road links and monitoring the light-based attributes for adverse road conditions to the UE 201.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 9100.

A computer called a server host 982 connected to the Internet hosts a process that provides a service in response to information received over the Internet. For example, server host 982 hosts a process that provides information representing video data for presentation at display 914. It is contemplated that the components of system 900 can be deployed in various configurations within other computer systems, e.g., host 982 and server 9102.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 9100 among others, through network link 978 and communications interface 970. In an example using the Internet 9100, a server host 982 transmits program code for a particular application, requested by a message sent from computer 900, through Internet 9100, ISP equipment 984, local network 980 and communications interface 970. The received code may be executed by processor 902 as it is received or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment may be implemented. Chip set 1000 is programmed to determine light-based attributes of one or more road links and monitor the light-based attributes for adverse road conditions as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for determining light-based attributes of one or more road links and monitoring the light-based attributes for adverse road conditions.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors. The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to determine light-based attributes of one or more road links and monitor the light-based attributes for adverse road conditions. The memory 1005 also stores the data associated with or generated by the execution of the inventive steps.

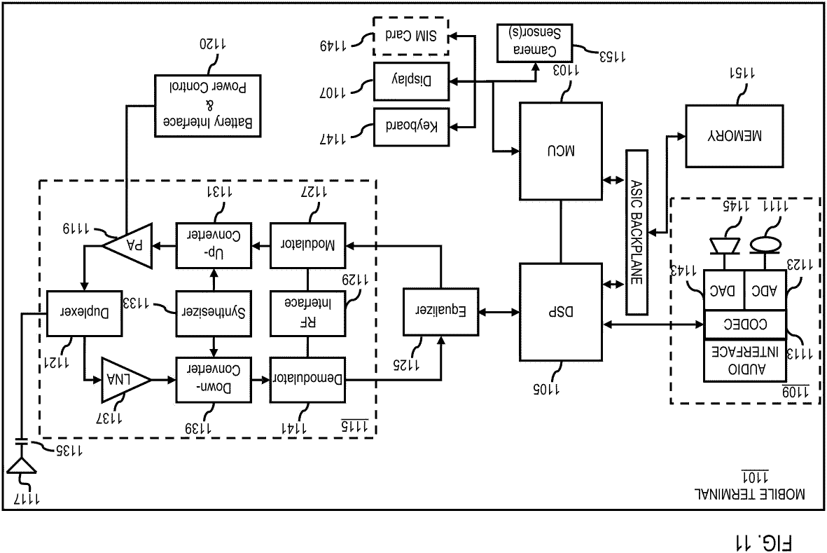

FIG. 11 is a diagram of exemplary components of a mobile terminal 1101 (e.g., a mobile device or vehicle or part thereof) for communications, which is capable of operating in the system of FIG. 2, according to one embodiment. In some embodiments, mobile terminal 1101, or a portion thereof, constitutes a means for determining light-based attributes of one or more road links and monitoring the light-based attributes for adverse road conditions. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover, if applicable, to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of determining light-based attributes of one or more road links and monitoring the light-based attributes for adverse road conditions determining light-based attributes of one or more road links and monitoring the light-based attributes for adverse road conditions. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to determine light-based attributes of one or more road links and monitor the light-based attributes for adverse road conditions. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Further, one or more camera sensors 1153 may be incorporated onto the mobile station 1101 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

We i claim:

1. An apparatus comprising at least one processor and at least one non-transitory memory including computer program code instructions, the computer program code instructions configured to, when executed, cause the apparatus to:
receive sensor data associated with a road segment;
generate a data point for a map layer associated with the road segment based on the sensor data, the data point indicating one or more natural light-based attributes of the road segment;
store the data point in a database associated with the map layer, wherein the map layer comprises the data point and one or more other data points that indicate the natural light-based attributes of one or more other road segments.

2. The apparatus of claim 1, wherein the one or more natural light-based attributes indicate: (i) a contrast level of natural light; (ii) an intensity level of the natural light; (iii) a temperature level of the natural light; or (iv) a combination thereof.

3. The apparatus of claim 1, wherein the one or more natural light-based attributes indicates one or more periods in which: (i) a contrast level of natural light is maintained; (ii) an intensity level of the natural light is maintained; (iii) a temperature of the natural light is maintained; or (iv) a combination thereof.

4. The apparatus of claim 1, wherein the database includes, for each of the road segment and the one or more other road segments, one or more past data points indicating the one or more natural light-based attributes.

5. The apparatus of claim 1, wherein the sensor data are received from: (i) a first sensor equipped by a vehicle that is traversing or has traversed the road segment; (ii) a second sensor disposed on the road segment; (iii) a third sensor equipped by a stationary road object disposed on the road segment; or (iv) a combination thereof.

6. The apparatus of claim 5, wherein the computer program code instructions are configured to, when executed, cause the apparatus to:
assign a weight for each one of the sensor data based a source that has provided each one of the sensor data, the source being the first sensor, the second sensor, or the third sensor; and
generate the data point based on the weight of each of the sensor data.

7. The apparatus of claim 6, wherein the weights of the sensor data received from first sensor, the second sensor, and the third sensor are equal to each other.

8. The apparatus of claim 6, wherein a first weight for each one of the sensor data received from the first sensor or the second sensor is greater than a second weight for each one of the sensor data received from the third sensor.

9. A non-transitory computer-readable storage medium having computer program code instructions stored therein, the computer program code instructions, when executed by at least one processor, cause the at least one processor to:
receive location information of a vehicle;
identify a target road segment associated with the location information;
determine whether the target road segment is affected by the adverse road condition by using a map layer, wherein the map layer comprises a plurality of data points associated with a plurality of road segments, and wherein each of the plurality of data points indicates light-based attributes of each of the plurality of road segments; and
responsive to the target road segment being impacted by the adverse road condition: (i) cause a notification to a user device associated with the vehicle; (ii) generate a route to an alternative road segment; or (iii) a combination thereof.

10. The non-transitory computer-readable storage medium of claim 9, wherein the adverse road condition indicates an event in which a state of visibility of one or more road objects within the road segment is obscured due to a glare.

11. The non-transitory computer-readable storage medium of claim 9, wherein the adverse road condition indicates an event in which natural light affecting the target road segment damages one or more physical objects within the target road segment.

12. The non-transitory computer-readable storage medium of claim 9, wherein the light-based attributes indicate: (i) contrast levels of light; (ii) intensity levels of the light; (iii) temperature levels of the light; or (iv) a combination thereof.

13. The non-transitory computer-readable storage medium of claim 9, wherein the computer program code instructions, when executed by at least one processor, cause the at least one processor to generate a route for a vehicle based on the road segment.

14. The non-transitory computer-readable storage medium of claim 9, wherein the computer program code instructions, when executed by at least one processor, cause the at least one processor to generate a command signal for deploying a drone to the road segment to mitigate the adverse road condition.

15. A method of providing a map layer, the method comprising:
receiving sensor data associated with a road segment;
generating a data point for a map layer associated with the road segment based on the sensor data, the data point indicating one or more light-based attributes of the road segment, wherein the one or more light-based attributes of the road segment indicate the adverse road condition; and
storing the data point in a database associated with the map layer, wherein the map layer comprises the data point and one or more other data points that indicate the one or more light-based attributes of one or more other road segments, and wherein the one or more light-based attributes of the one or more other road segments indicates the adverse road condition or one or more other adverse road conditions.

16. The method of claim 15, wherein the adverse road condition indicates an event in which a state of visibility of one or more road objects within the road segment is obscured due to a glare.

17. The method of claim 15, wherein the adverse road condition indicates an event in which light affecting the road segment damages one or more physical objects within the road segment.

18. The method of claim 15, wherein the generating the data point for the map layer comprises:
inputting the sensor data to a machine learning model; and
receiving the data point from the machine learning model, wherein the machine learning model is trained by using historical data including past light-based attributes of the road segment and ground truth data indicating true states of the road segment corresponding to the past light-based attributes.

19. The method of claim 15, wherein the one or more light-based attributes indicates: (i) a contrast level of light; (ii) an intensity level of the light; (iii) a temperature level of the light; or (iv) a combination thereof.

20. The method of claim 15, wherein the sensor data are received from: (i) a first sensor equipped by a vehicle that is traversing or has traversed the road segment; (ii) a second sensor disposed on the road segment; (iii) a third sensor equipped by a stationary road object disposed on the road segment; or (iv) a combination thereof.
